(19) United States
(12) Patent Application Publication
(10) Pub. No.: US 2016/0076815 A1
(43) Pub. Date: Mar. 17, 2016

(54) HEAT EXCHANGER

(71) Applicant: DANFOSS MICRO CHANNEL HEAT EXCHANGER (JIAXING) CO., LTD., Jiaxing, Zhejiang (CN)

(72) Inventors: Hongbing Chen, Zhejiang (CN); Jianlong Jiang, Zhejiang (CN); Yang Xu, Zhejiang (CN); Kaiquan Li, Zhejiang (CN); Jeffrey Lee Tucker, Zhejiang (CN)

(21) Appl. No.: 14/888,224

(22) PCT Filed: May 8, 2014
(86) PCT No.: PCT/CN2014/077038

§ 371 Date: Oct. 30, 2015

(30) Foreign Application Priority Data
May 10, 2013 (CN) 201310176381.4

(51) Int. Cl. F28D 1/04; F25B 39/00; B23P 15/26; F28F 1/32

(52) U.S. Cl. CPC F28D 1/04; F28F 1/325; F25B 39/00; B23P 15/26; F28F 2275/10

(57) ABSTRACT

Disclosed is a heat exchanger (100), comprising a heat exchange tube (10), fins (20) and rings (30), wherein the fin (20) comprises a tubular part (21), and the ring (30) is used for fastening the tubular part (21) onto the heat exchange tube (10). A pressure is exerted in an axial direction of the heat exchange tube (10) on the tubular parts (21) of fins (20) and the rings (30) which are alternately sheathed onto the heat exchange tube (10), so as to fit the tubular part (21) together with the ring (30) in such a way that one is sheathed onto the other, thereby fixing the tubular parts (21) of the fins (20) onto the heat exchange tube (10). When the diameter of the heat exchange tube is relatively small, the tube expansion technique cannot be used for the connection of the heat exchange tube and the fins, and the heat exchanger (100) can avoid the complicated soldering process, thereby improving the product quality, and reducing the manufacturing costs of the product and the equipment investment.

### CROSS-REFERENCE TO RELATED APPLICATIONS

This application is entitled to the benefit of and incorporates by reference subject matter disclosed in the International Patent Application No. PCT/CN2014/077038 filed on May 8, 2014 and Chinese Patent Application No. 201310176381.4 filed on May 10, 2013.

### TECHNICAL FIELD

The present invention relates to a heat exchanger.

### BACKGROUND ART

With reference to FIG. 1, a heat exchanger 100 comprises fins 20 and heat exchange tubes 10, the fins comprising tubular parts. The tubular parts of the fins are fastened onto the heat exchange tubes. In general, a mechanical tube expansion process and a soldering process are used for fastening the tubular parts of the fins onto the heat exchange tubes. For a given size of heat exchanger, the smaller the hydraulic diameter of the heat exchange tubes is, the higher the heat exchange performance is and the lower the material costs are. However, the mechanical tube expansion technique is greatly affected by the diameter of the heat exchange tubes, and currently can only be applied to copper tubes with a diameter larger than 5 mm, and aluminium tubes are not suitable for this technique. This is a great limitation of the current unlimited pursuit of cost-effectiveness in the air-conditioning industry. The soldering technique can be used for heat exchangers having heat exchange tubes with small hydraulic diameter; however, the problems, such as complex soldering process, high equipment investment, and unstable product quality, greatly limit the market competitiveness of micro-channel heat exchangers.

### SUMMARY

An object of the present invention is to provide a heat exchanger and a method for manufacturing the heat exchanger, which not only can be used for tube-fin type heat exchangers, particularly the heat exchangers with heat exchange tubes of a diameter smaller than 5 mm, but can also be used for micro-channel heat exchangers, while ensuring the heat exchange performance, for instance, and this technique can replace the soldering and mechanical tube expansion techniques.

According to an aspect of the present invention, provided is a heat exchanger, comprising: a heat exchange tube; fins, comprising tubular parts; and rings for fastening the tubular part of the fin onto the heat exchange tube, wherein the tubular parts of the fins and the rings are alternately sheathed onto the heat exchange tube, and a pressure is exerted in an axial direction of the heat exchange tube on the tubular parts of the fins and the rings which are alternately sheathed onto the heat exchange tube, so as to fit the tubular part together with the ring in such a way that one is sheathed onto the other, for instance, a pressure is exerted in an axial direction of the heat exchange tube simultaneously on all the tubular parts of the fins and the rings which are alternately sheathed onto the heat exchange tube, so as to fit all the tubular parts and rings together in such a way that one is sheathed onto the other.

According to a further aspect of the present invention, the length of said ring in the axial direction is approximately equal to or greater than the length of the tubular part in the axial direction.

According to a further aspect of the present invention, the fin further comprises a substantially flat main body part and an annular protrusion part extending from the main body part to one side thereof, said tubular part extending from an end portion of said annular protrusion part that is remote from the main body part and being integrally formed with said annular protrusion part, and after the pressure is exerted on the tubular parts of the fins and the rings which are alternately sheathed onto the heat exchange tube, said annular protrusion part deforms.

According to a further aspect of the present invention, said annular protrusion part comprises a cone-shaped part.

According to a further aspect of the present invention, a wall of said tubular part has the shape of a conical surface, for instance, the wall of said tubular part is provided at an angle of 0-10 degrees or 0-25 degrees relative to the axial direction.

According to a further aspect of the present invention, a wall of the ring fitted with the tubular part has the shape of a conical surface, for instance, the wall of the ring fitted with the tubular part is provided at an angle of 1-3 degrees relative to the axial direction.

According to a further aspect of the present invention, said ring is fitted to an outer periphery of the tubular part.

According to a further aspect of the present invention, the wall of said cone-shaped part is provided at an angle of 45-90 degrees relative to the axial direction.

According to a further aspect of the present invention, said ring is fitted to an inner periphery of the tubular part, and an inner periphery of said ring is fitted to an outer periphery of the heat exchange tube.

According to a further aspect of the present invention, the length of said ring in the axial direction is approximately equal to or greater than 30% of the length of the tubular part in the axial direction.

According to a further aspect of the present invention, said ring has a groove extending in the axial direction.

According to a further aspect of the present invention, said groove extends from an axial end portion of said ring to an axial middle portion thereof.

According to a further aspect of the present invention, said tubular part has a groove extending in the axial direction.

According to a further aspect of the present invention, said annular protrusion part has a groove extending in the axial direction.

According to a further aspect of the present invention, the rings are arranged in one or more rows, two adjacent rings are connected via a connecting member, and the rings respectively correspond to the tubular parts on the fins.

According to another aspect of the present invention, provided is a method for manufacturing a heat exchanger, the method comprising the following steps: alternately sheathing tubular parts of fins and rings onto a heat exchange tube, and exerting a pressure in an axial direction of the heat exchange tube on the tubular parts of the fins and the rings which are alternately sheathed onto the heat exchange tube, so as to fit the tubular part together with the ring in such a way that one is sheathed onto the other.

The heat exchanger and the method for manufacturing the heat exchanger according to the present invention not only can be used for tube-fin type heat exchangers, particularly heat exchangers with heat exchange tubes of a diameter smaller than 5 mm, but can also be used for micro-channel heat exchangers, while ensuring the heat exchange performance, and this technique can replace the soldering and mechanical tube expansion techniques.

The smaller the diameter of the heat exchange tube is, the higher the heat exchange performance is and the lower the material costs are. When the diameter of the heat exchange tube is relatively small, the tube expansion technique cannot be used for the connection of the heat exchange tube and the fins, and the heat exchanger and the method for manufacturing the heat exchanger according to the present invention can avoid the complicated soldering process, thereby improving the product quality, and reducing the manufacturing costs of the product and the equipment investment.

### BRIEF DESCRIPTION OF THE DRAWINGS

FIG. 1 is a schematic view of a heat exchanger according to an embodiment of the present invention;

FIG. 2 is a schematic front view of fins of a heat exchanger according to a first embodiment of the present invention before assembly;

FIG. 3 is a schematic left view of the fins of the heat exchanger according to the first embodiment of the present invention before assembly;

FIG. 4a is a schematic enlarged front view of the fins of the heat exchanger according to the first embodiment of the present invention before assembly;

FIG. 4b is a schematic enlarged bottom view of the fins of the heat exchanger according to the first embodiment of the present invention before assembly;

FIG. 5a is a schematic enlarged front view of the fins of the heat exchanger according to a further example of the first embodiment of the present invention before assembly;

FIG. 5b is a schematic enlarged bottom view of the fins of the heat exchanger according to the further example of the first embodiment of the present invention before assembly;

FIG. 6 is a schematic enlarged bottom view of the fins of the heat exchanger according to another example of the first embodiment of the present invention before assembly;

FIG. 7a is a schematic view of a heat exchange tube, a tubular part of the fin and a ring of the heat exchanger according to the first embodiment of the present invention before compression;

FIG. 7b is a schematic view of the heat exchange tube, the tubular part of the fin and the ring of the heat exchanger according to the first embodiment of the present invention after compression;

FIG. 8 is a schematic view of the heat exchange tubes, the tubular parts of the fins and the rings of the heat exchanger according to the first embodiment of the present invention before compression, showing the alternate arrangement of the tubular parts of the fins and the rings;

FIG. 9a is a schematic sectional view of the ring of the heat exchanger according to the first embodiment of the present invention;

FIG. 9b is a schematic front view of the ring of the heat exchanger according to the first embodiment of the present invention;

FIG. 10a is a schematic front view of a set of rings of the heat exchanger according to the first embodiment of the present invention;

FIG. 10b is a schematic top view of the set of rings of the heat exchanger according to the first embodiment of the present invention;

FIG. 11a is a schematic view of a heat exchange tube, a tubular part of a fin and a ring of a heat exchanger according to a second embodiment of the present invention before compression;

FIG. 11b is a schematic view of the heat exchange tube, the tubular part of the fin and the ring of the heat exchanger according to the second embodiment of the present invention after compression;

FIG. 12 is a schematic view of the heat exchange tube, the tubular part of the fin and the ring of the heat exchanger according to a further example of the second embodiment of the present invention after compression;

FIG. 13a is a schematic enlarged front view of the fin of the heat exchanger according to the second embodiment of the present invention before assembly;

FIG. 13b is a schematic enlarged bottom view of the fin of the heat exchanger according to the second embodiment of the present invention before assembly;

FIG. 14 is a schematic view of the ring of the heat exchanger according to the second embodiment of the present invention;

FIG. 15a is a schematic front view of one example of the ring of the heat exchanger according to the second embodiment of the present invention;

FIG. 15b is a schematic top view of one example of the ring of the heat exchanger according to the second embodiment of the present invention;

FIG. 15c is a schematic front view of a further example of the ring of the heat exchanger according to the second embodiment of the present invention;

FIG. 15d is a schematic top view of the further example of the ring of the heat exchanger according to the second embodiment of the present invention;

FIG. 16a is a schematic front view of the ring of the heat exchanger according to an embodiment of the present invention;

FIG. 16b is a schematic top view of the ring of the heat exchanger according to an embodiment of the present invention; and

FIG. 17 is a schematic view of an apparatus for manufacturing a heat exchanger according to an embodiment of the present invention.

### DETAILED DESCRIPTION

The present invention will be further described below in conjunction with the accompanying drawings and specific embodiments.

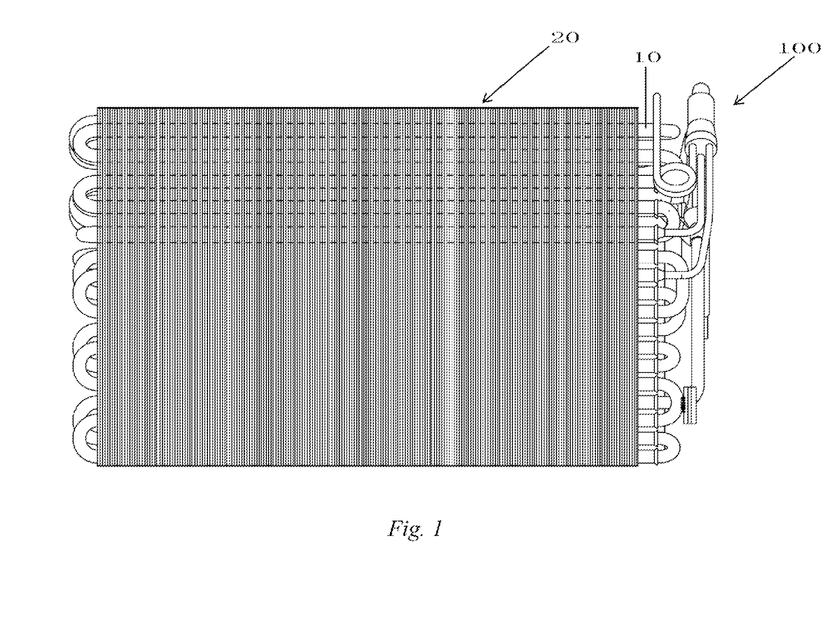

A heat exchanger 100 according to an embodiment of the present invention is shown in FIG. 1. As shown in FIG. 1, the heat exchanger 100 comprises a heat exchange tube 10 and a fin 20. The heat exchange tube 10 may have any cross-sectional shape, the heat exchange tube 10 passes through a tubular part 21 on the fin 20, and multiple fins 20 are stacked together.

### Embodiment 1

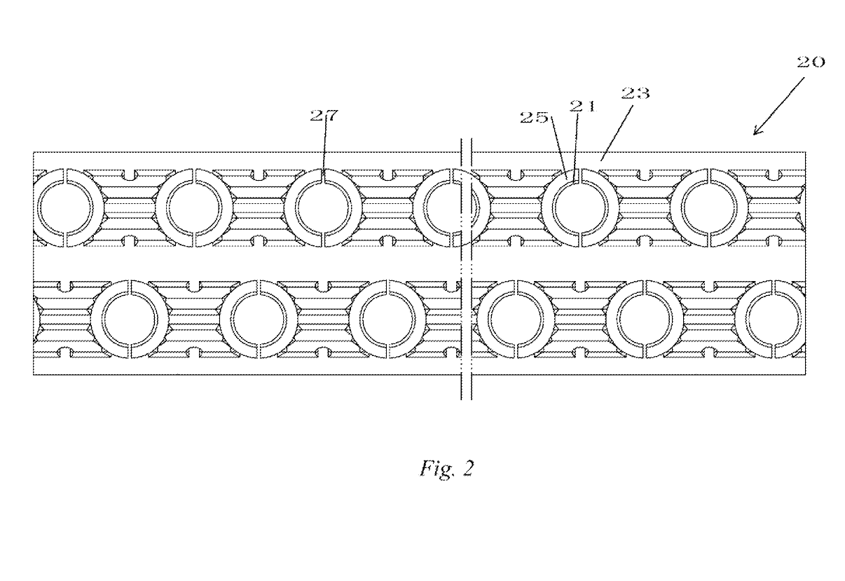

As shown in FIGS. 2-8, the fin 20 comprises the tubular part 21, and the heat exchanger 100 further comprises a ring 30, which ring 30 is used for fastening the tubular part 21 of the fin 20 onto the heat exchange tube 10. The inner diameter of the tubular part 21 may be approximately equal to the outer diameter of the heat exchange tube 10, or may be slightly larger than the outer diameter of the heat exchange tube 10.

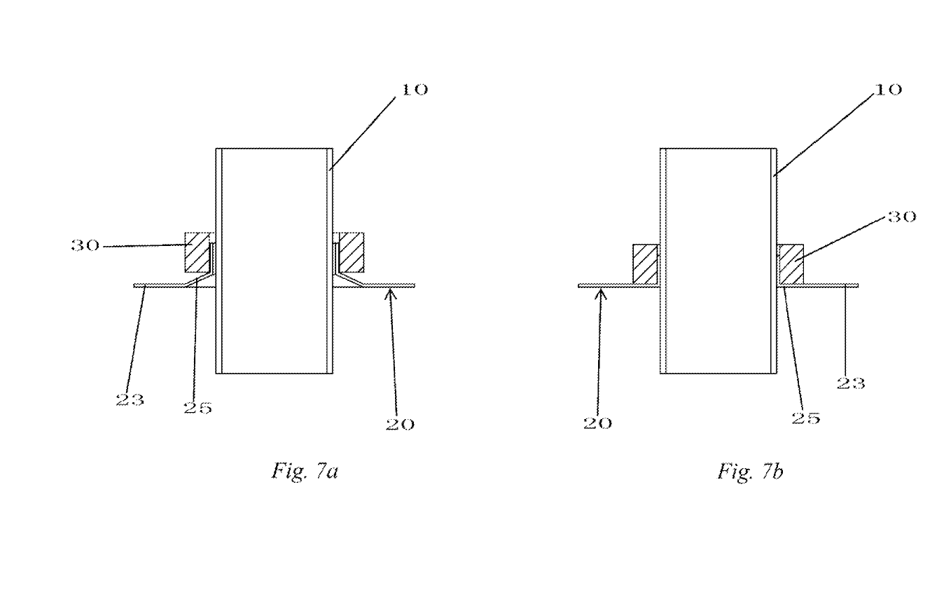

As shown in FIGS. 7a, 7b and 8, the tubular parts 21 of the fins 20 and the rings 30 are alternately sheathed onto the heat exchange tube 10, and a pressure is exerted in an axial direction of the heat exchange tube 10 on the tubular parts 21 of the fins 20 and the rings 30 which are alternately sheathed onto the heat exchange tube 10, so as to fit the tubular part 21 together with the ring 30 in such a way that one is sheathed onto the other. Under the action of an external force, the rings 30 are pressed down and meanwhile the close contact between the heat exchange tube 10 and the fins 20 can be ensured. In the embodiment shown in FIGS. 2-8, the ring 30 is sheathed onto the tubular part 21, that is to say, the ring 30 is fitted to an outer periphery of the tubular part 21. The ring 30, the tubular part 21 and the heat exchange tube 10 may be approximately coaxially fitted together with one another. A pressure, for instance, is exerted in an axial direction of the heat exchange tube simultaneously on all the tubular parts of the fins and the rings which are alternately sheathed onto the heat exchange tube, so as to fit all the tubular parts and rings together in such a way that one is sheathed onto the other. That is to say, the process of exerting pressure can be carried out once to fit all the tubular parts of the fins and the rings on one or each heat exchange tube together with each other in such a way that one is sheathed onto the other.

As shown in FIGS. 7a-9b, the length of the ring 30 in the axial direction may be approximately equal to or greater than the length of the tubular part 21 in the axial direction. For instance, the axial direction may be the axial direction of the assembled heat exchange tube 10.

As shown in FIGS. 2-4 and 7a-8, the fin 20 further comprises a substantially flat main body part 23 and an annular protrusion part 25 extending or protruding from the main body part 23 to one side thereof, the tubular part 21 extending from an end portion of the annular protrusion part 25 that is remote from the main body part 23 and being integrally formed with the annular protrusion part 25, and after the pressure is exerted on the tubular parts 21 of the fins 20 and the rings 30 which are alternately sheathed onto the heat exchange tube 10, the annular protrusion part 25 and the main body part 23 deform, such that, for instance, the annular protrusion part 25 and the main body part 23 are approximately located in the same plane, or compared with the situation in which they are not deformed, the annular protrusion part 25 is closer to the main body part 23 (or closer to the plane where the main body part 23 is located), or the protrusion thereof from the main body part 23 is smaller. In addition, for instance, the axial direction of the tubular part 21 and of the annular protrusion part 25 may be approximately perpendicular to the main body part 23. In the embodiment shown in FIGS. 2-4 and 7a-8, the annular protrusion part 25 of the fin 20 of the heat exchanger 100 is embodied as a cone-shaped part.

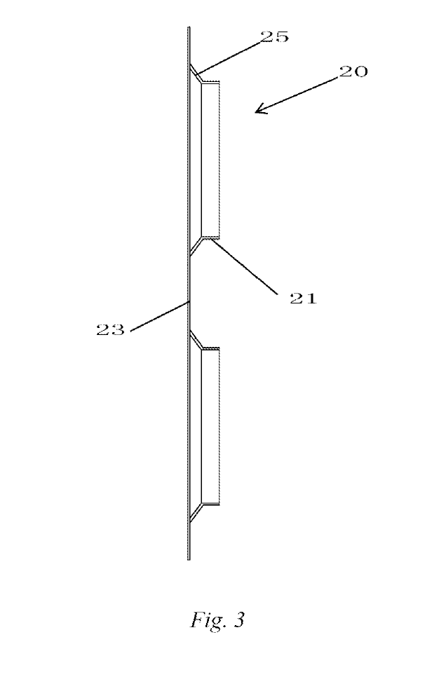

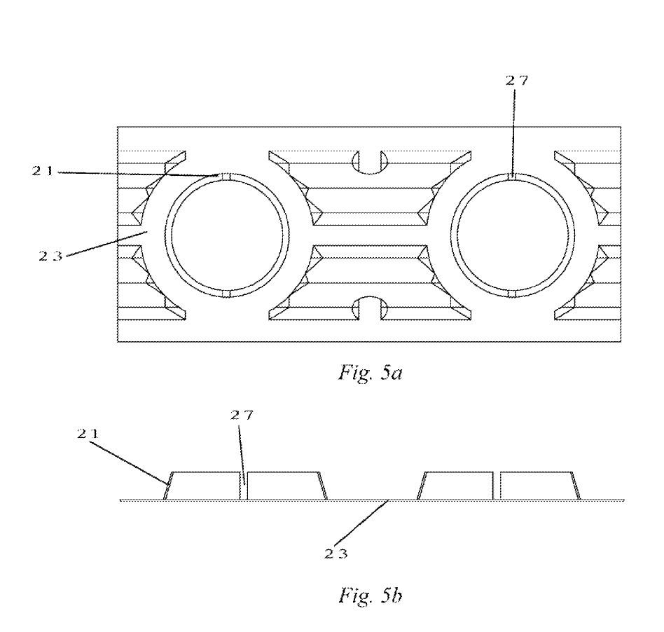

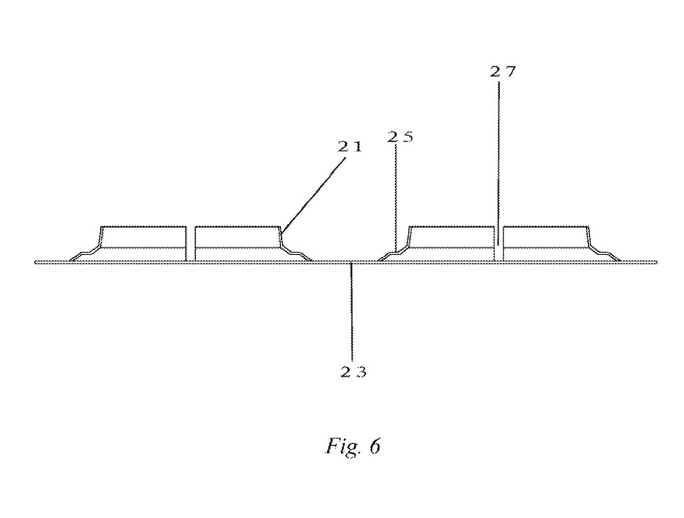

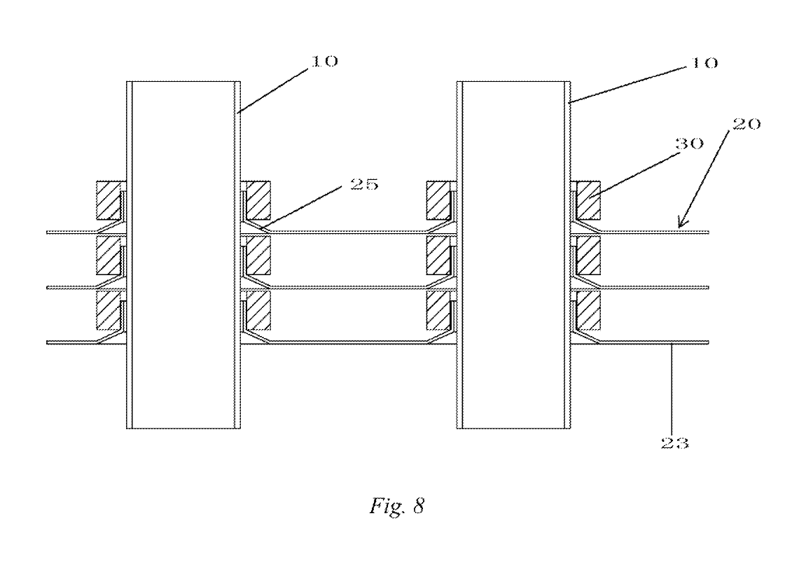

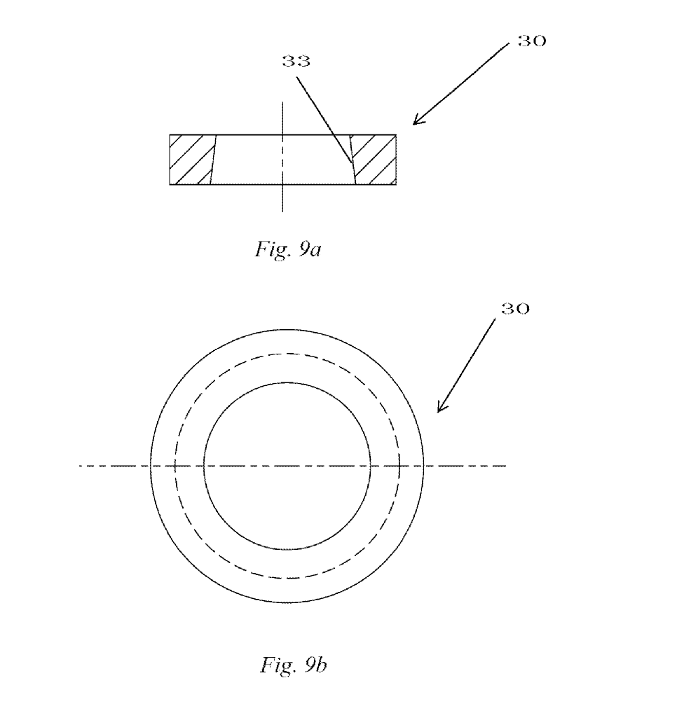

As shown in FIGS. 2-9b, a wall of the tubular part 21 has the shape of a conical surface, for instance, the wall of the tubular part 21 may be provided at an angle of 0-25 degrees relative to the axial direction. The wall of the tubular part 21 may also have a cylindrical shape. Furthermore, the wall of the tubular part 21 may also have any other suitable shape. As shown in FIG. 9a, a wall 33 of the ring 30 fitted with the tubular part 21 (an inner wall of the ring 30) has the shape of a conical surface, for instance, the wall 33 of the ring 30 fitted with the tubular part 21 (the inner wall of the ring 30) may be provided at an angle of 1-3 degrees relative to the axial direction. As shown in FIGS. 3 and 6, the wall of the cone-shaped part 25 may be provided at an angle of 45-90 degrees relative to the axial direction. For instance, the axial direction may be the axial direction of the assembled heat exchange tube 10.

As shown in FIGS. 2-6, the tubular part 21 and the cone-shaped part 25 may have a groove 27 extending in the axial direction of the tubular part 21 and the cone-shaped part 25, and more particularly, the wall of the tubular part 21 and the cone-shaped part 25 may have a groove 27 extending in the axial direction of the tubular part 21 and the cone-shaped part 25. For instance, the groove 27 extends over the entire length in the axial direction of the tubular part 21 and the cone-shaped part 25, and the grooves 27 of the tubular part 21 and the cone-shaped part 25 are connected together and are approximately in one plane. The number of grooves 27 may be 2, 3 or more.

As shown in FIGS. 7a-8, the heat exchange tube 10 is inserted into the tubular part 21 of the fin, the ring 30 is sheathed onto the tubular part 21, and the annular protrusion part 25 and the groove 27 are provided on the fin 21; and under the action of an external force, the ring 30 is pressed down and meanwhile the close contact between the heat exchange tube 10 and the fin 20 can be ensured.

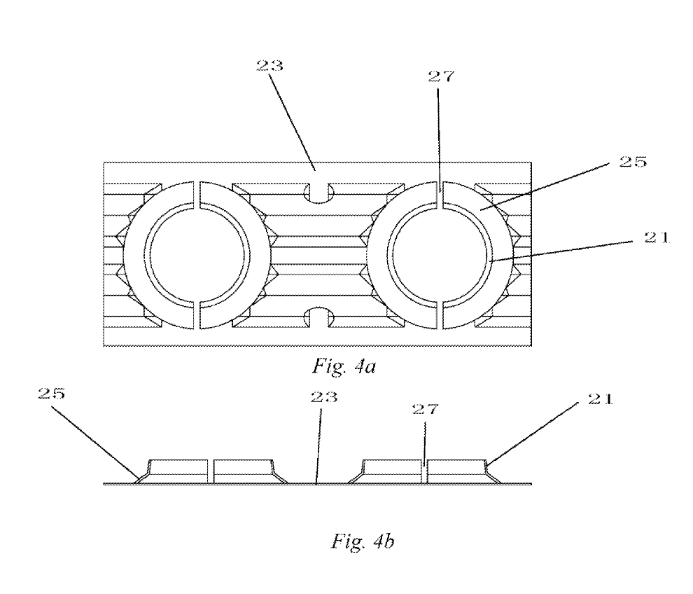

As shown in FIGS. 5a and 5b, the fin 20 of the heat exchanger 100 may not have an annular protrusion part 25 but only the tubular part 21, the tubular part 21 extends from the main body part 23 to one side thereof, and the tubular part 21 is directly and integrally connected to the main body part 23. For instance, the axial direction of the tubular part 21 may be approximately perpendicular to the main body part 23.

As shown in FIG. 6, the annular protrusion part 25 of the fin 20 of the heat exchanger 100 may have any suitable shape, and the annular protrusion part may comprise one or more cone-shaped parts, for instance, two cone-shaped parts.

In the above-mentioned embodiment, the ring 30 is fitted to the outer periphery of the tubular part 21, and the tubular part 21 can be fixed onto the heat exchange tube 10 by means of the interference fit of the ring 30 and the tubular part 21, for instance, a hole part of the ring 30 is chamfered at two ends, so that by means of an axial pressure, the ring 30 is pressed onto the tubular part 21, so as to fix the tubular part 21 onto the heat exchange tube 10. As an alternative, the inner wall 33 of the ring 30 may have the shape of a cone surface, such that by means of an axial pressure, the ring 30 is pressed onto the tubular part 21, so as to fix the tubular part 21 onto the heat exchange tube 10. The inner wall 33 of the ring 30 may have the shape of a cone surface, or have the shape of a cylindrical surface.

In the above-mentioned embodiment, the tubular part 21 has a groove 27, or the tubular part 21 and the annular protrusion part 25 have a groove 27. As an alternative, the tubular part 21 and the annular protrusion part 25 may not have a groove 27; instead, the ring 30 is pressed onto the tubular part 21 such that the tubular part 21 deforms to fix the tubular part 21 onto the heat exchange tube 10.

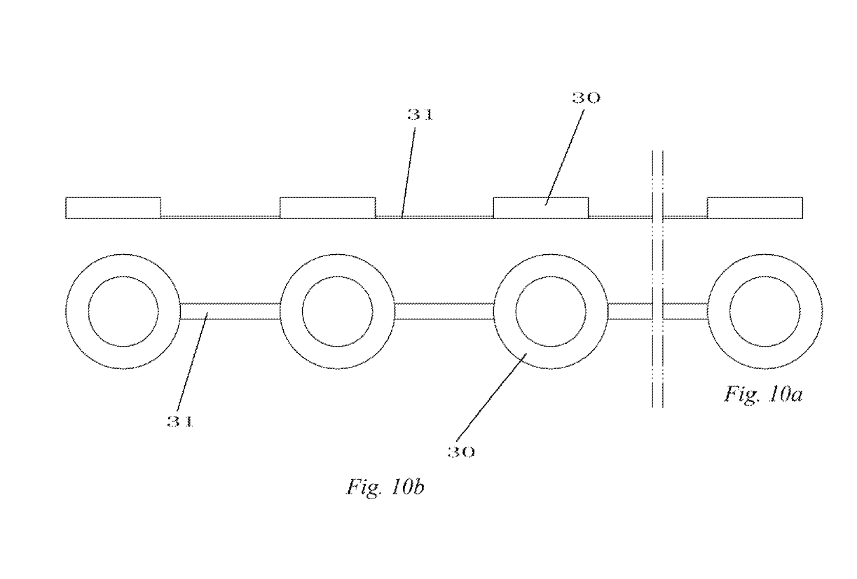

The rings 30 may be separately formed, or as shown in FIGS. 10a and 10b, the rings 30 may be formed as a set of rings 30, and the rings 30 may be arranged in one or more rows. For instance, a set of rings 30 may comprise multiple rings 30, two adjacent rings 30 are connected via a connecting member 31, and the connecting member 31 may be a rod-like member. The number of rings 30 contained in one set of rings 30 may be equal to the number of tubular parts 21 in one row of tubular parts of the fins 20, or the number of tubular parts 21 in one row of tubular parts of the fins 20 is an integer multiple of the number of rings 30 contained in one set of rings 30. As an alternative, the number of rings 30 contained in one set of rings 30 may be any value. The rings 30 contained in one set of rings are approximately arranged along a straight line. The spacing between two rings 30 is approximately equal to the spacing between the heat exchange tubes 10 or the spacing between the tubular parts 21. Furthermore, the rings 30 may be formed as an array, such as a rectangular array, two adjacent rings are connected via a connecting member 31, and all the rings 30 respectively correspond to the tubular parts 21 on the fins.

### Embodiment 2

Only the difference between the second embodiment and the first embodiment is described below.

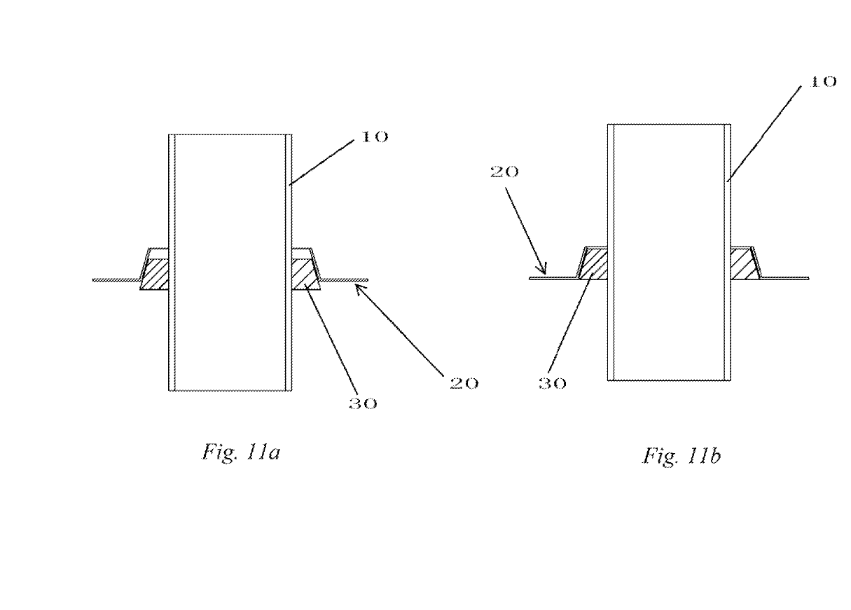

With reference to FIGS. 11a-13b, the fin 20 comprises a tubular part 21. The tubular part 21 extends from a main body part 23 to one side thereof, i.e. the tubular part 21 is directly and integrally connected to the main body part 23. For instance, the axial direction of the tubular part 21 may be approximately perpendicular to the main body part 23. In the second embodiment, the ring 30 is fitted onto the inner periphery of the tubular part 21, and the inner periphery of the ring 30 is fitted onto the outer periphery of the heat exchange tube 10. That is to say, the tubular part 21 is sheathed onto the ring 30, and the ring 30 is sheathed onto the heat exchange tube 10. The inner diameter of the ring 30 may be equal to or slightly larger than the outer diameter of the heat exchange tube 10.

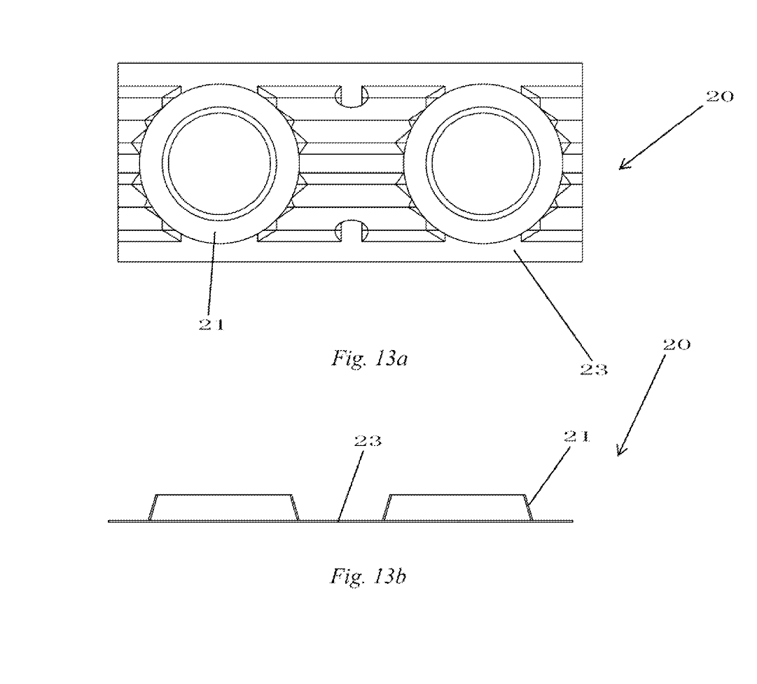

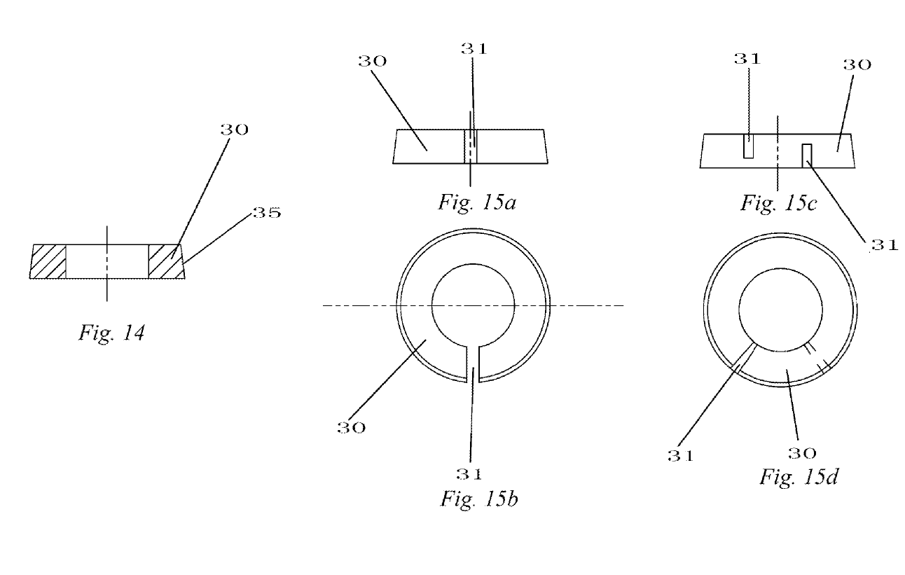

As shown in FIG. 14, a wall 35 of the ring 30 fitted with the tubular part 21 (an outer wall of the ring 30) has the shape of a conical surface, for instance, the wall 35 of the ring 30 fitted with the tubular part 21 (the outer wall of the ring 30) may be provided at an angle of 1-3 degrees relative to the axial direction.

As shown in FIGS. 15a and 15b, the ring 30 has a groove 31 extending in the axial direction. That is to say, the ring 30 is formed as an opening ring. As shown in FIGS. 15c and 15d, the groove 31 may extend from an axial end portion of the ring 30 to an axial middle portion of the ring 30. For instance, two or more grooves 31 may respectively extend from an axial end portion of the ring 30 to the axial middle portion of the ring 30, and the total length of one groove extending from one end and one groove extending from the other end may be larger than the length of the ring 30 in the axial direction, or may be smaller than or equal to the length of the ring 30 in the axial direction. According to an example, the length of the groove 31 in the axial direction of the ring 30 may be larger than ¾ of the axial length of the ring 30.

In the embodiment shown in FIGS. 11a and 11b, the ring 30 is sheathed onto the heat exchange tube 10, the tubular part 21 is then sheathed onto the ring 30, an external force is applied to press the fin 20 down, and the ring 30, being able to constrict (due to being deformable or/and having a groove), holds the heat exchange tube 10 tightly, thereby ensuring the close contact of the fin 20, the heat exchange tube 10 and the ring 30.

In the above-mentioned embodiment, the ring 30 is fitted to the inner periphery of the tubular part 21, the tubular part 21 can be fixed onto the ring 30 by means of the interference fit of the ring 30 and the tubular part 21, and the ring 30 is fixed onto the heat exchange tube 10, for instance, by means of an axial pressure, the ring 30 is pressed into the tubular part 21, so as to fix the ring 30 onto the heat exchange tube 10 and fix the tubular part 21 onto the ring 30. As an alternative, the wall of the tubular part 21 may have the shape of a cone surface, and/or the outer wall of the ring 30 may have the shape of a cone surface, such that by means of an axial pressure, the ring 30 is pressed into the tubular part 21, so as to fix the tubular part 21 onto the heat exchange tube 10.

In the above-mentioned embodiment, the ring 30 has a groove 31. As an alternative, the ring 30 may not have a groove 31; instead, the ring 30 is pressed into the tubular part 21 such that the ring 30 deforms to fix the ring 30 onto the heat exchange tube 10, so as to fix the tubular part 21 onto the ring 30.

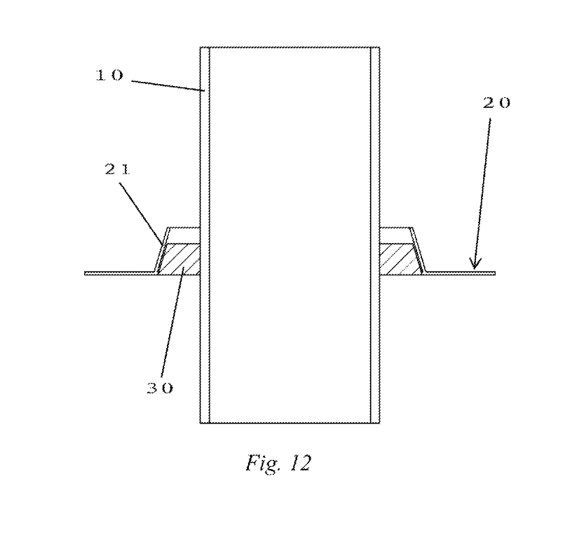

As shown in FIGS. 11b and 12, the length of the ring 30 in the axial direction may be approximately equal to or greater than the length of the tubular part 21 in the axial direction. For instance, the axial direction may be the axial direction of the assembled heat exchange tube 10. As an alternative, the length of the ring 30 in the axial direction may also be less than the length of the tubular part 21 in the axial direction. In this case, after the rings 30, the tubular parts 21 and the heat exchange tube 10 are fitted together with one another, part of the wall of the tubular parts 21 may be located between the rings 30. According to an example of the present invention, the length of the ring 30 in the axial direction is approximately equal to or greater than 30% of the length of the tubular part 21 in the axial direction.

As shown in FIGS. 13a and 13b, the wall of the tubular part 21 has the shape of a conical surface, for instance, the wall of the tubular part 21 may be provided at an angle of 0-25 degrees relative to the axial direction. The wall of the tubular part 21 may also have a cylindrical shape. Furthermore, the wall of the tubular part 21 may also have any other suitable shape.

The material of the ring 30 may be a material with a high thermal conductivity.

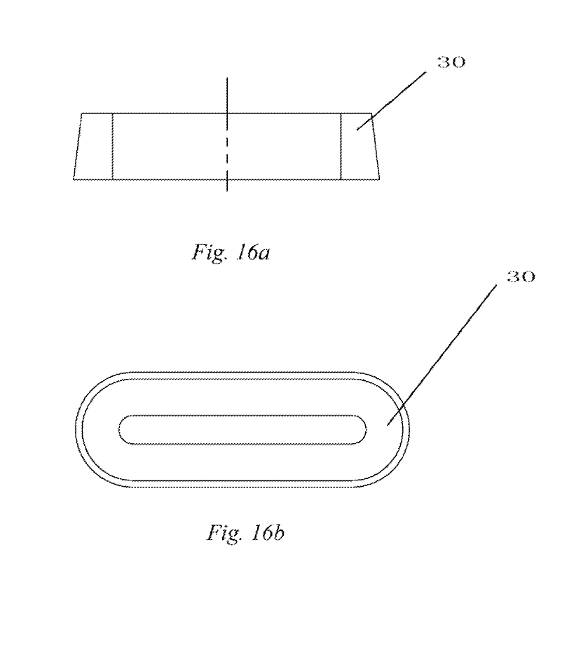

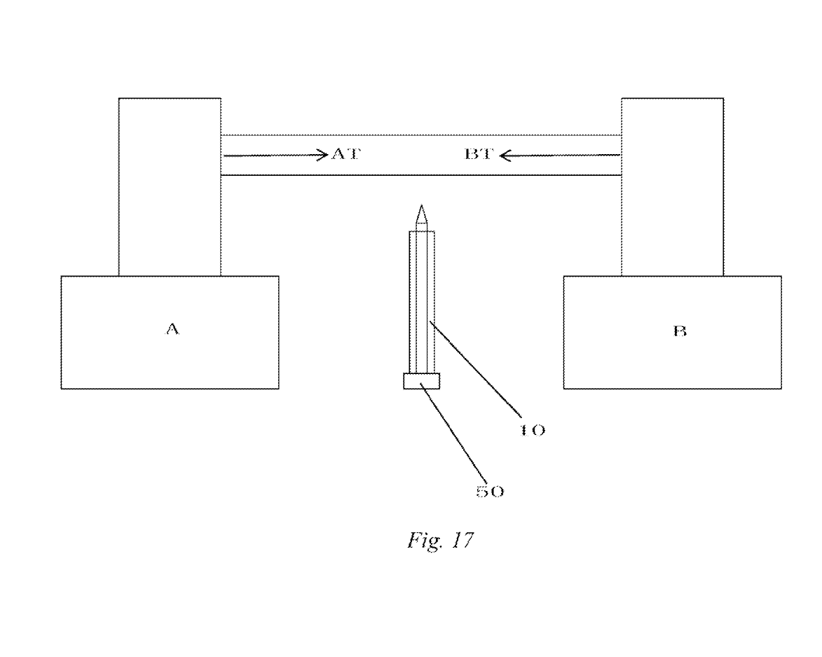

As shown in FIGS. 16a and 16b, the ring 30 may be correspondingly shaped depending on the cross-sectional shape of the heat exchange tube 10, for instance, the ring 30 may have a circular shape, an oval shape, or a shape corresponding to the cross-sectional shape of a flat tube serving as the heat exchange tube. The tubular part 21 may also have the corresponding shape.

The method of manufacturing a heat exchanger according to the present invention will be described below.

The method of manufacturing a heat exchanger according to the present invention is described below with reference to FIGS. 8 and 17.

Fins 20 are formed by an apparatus A such as a fin-punching apparatus (such as a punch, a press), and rings 30 are formed by an apparatus B such as a ring punching apparatus (such as a punch, a press). For instance, a metal sheet is used to form an integral fin 20 by means of punching, and a metal sheet is used to form an integral ring 30 by means of punching. With a transfer mechanism, the fins 20 formed by the apparatus A are transported to an assembly station in the direction AT, while the rings 30 formed by the apparatus B are transported to the assembly station in the direction BT, and a heat exchange tube 10 is fixed onto a bracket 50.

The tubular parts 21 of the fins 20 and the rings 30 are alternately sheathed onto the heat exchange tube 10, and a pressure is exerted in an axial direction of the heat exchange tube on the tubular parts 21 of the fins 20 and the rings 30 which are alternately sheathed onto the heat exchange tube 10, so as to fit the tubular part 21 together with the ring 30 in such a way that one is sheathed onto the other. For instance, the tubular part 21 is sheathed onto the ring 30, or the ring 30 is sheathed onto the tubular part 21. For instance, the tubular part 21 and the ring 30 are tightly compressed by a compression device (such as a press). A pressure, for instance, is exerted in an axial direction of the heat exchange tube simultaneously on all the tubular parts of the fins and the rings which are alternately sheathed onto the heat exchange tube, so as to fit all the tubular parts and rings together in such a way that one is sheathed onto the other. That is to say, the process of exerting pressure is carried out once to fit all the tubular parts of the fins and the rings on one or each heat exchange tube together with each other in such a way that one is sheathed onto the other.

This processing method can be used with automatic control, has a stable product quality and a high efficiency, and can adapt to processing by high speed punch. The method of the present invention is suitable for both single-row heat exchangers and multi-row heat exchangers.

The smaller the diameter of the heat exchange tube is, the higher the heat exchange performance is and the lower the material costs are. When the diameter of the heat exchange tube is relatively small, the tube expansion technique cannot be used for the connection of the heat exchange tube and the fins, and the technical solution of the present invention can avoid the complicated soldering process, thereby improving the product quality, and reducing the manufacturing costs of the product and the equipment investment.

It should be noted that all or part of the technical features of the above embodiments of the present invention can be combined in any suitable manner to form new embodiments.

The embodiments described above are provided by way of example only. The skilled person will be aware of many modifications, changes and substitutions that could be made without departing from the scope of the present disclosure. The claims of the present disclosure are intended to cover all such modifications, changes and substitutions as fall within the spirit and scope of the disclosure.

What is claimed is:

1. A heat exchanger comprising:
a heat exchange tube;
fins, comprising tubular parts; and
rings for fastening the tubular part of the fin onto the heat exchange tube,
wherein the tubular parts of the fins and the rings are alternately sheathed onto the heat exchange tube, and a pressure is exerted in an axial direction of the heat exchange tube on the tubular parts of the fins and the rings which are alternately sheathed onto the heat exchange tube, so as to fit the tubular part together with the ring in such a way that one is sheathed onto the other.

2. The heat exchanger as claimed in claim 1, wherein
the length of said ring in the axial direction is approximately equal to or greater than the length of the tubular part in the axial direction.

3. The heat exchanger as claimed in claim 1, wherein
the fin further comprises a substantially flat main body part and an annular protrusion part extending from the main body part to one side thereof, said tubular part extending from an end portion of said annular protrusion part that is remote from the main body part and being integrally formed with said annular protrusion part, and
after the pressure is exerted on the tubular parts of the fins and the rings which are alternately sheathed onto the heat exchange tube, said annular protrusion part deforms.

4. The heat exchanger as claimed in claim 3, wherein
said annular protrusion part comprises a cone-shaped part.

5. The heat exchanger as claimed in claim 1, wherein
a wall of said tubular part has the shape of a conical surface.

6. The heat exchanger as claimed in claim 1, wherein
a wall of said tubular part is provided at an angle of 0-25 degrees relative to the axial direction.

7. The heat exchanger as claimed in claim 1, wherein
a wall of the ring fitted with the tubular part has the shape of a conical surface.

8. The heat exchanger as claimed in claim 1, wherein
a wall of the ring fitted with the tubular part is provided at an angle of 1-3 degrees relative to the axial direction.

9. The heat exchanger as claimed in claim 1, wherein
said ring is fitted to an outer periphery of the tubular part.

10. The heat exchanger as claimed in claim 4, wherein
a wall of said cone-shaped part is provided at an angle of 45-90 degrees relative to the axial direction.

11. The heat exchanger as claimed in claim 1, wherein
said ring is fitted to an inner periphery of the tubular part, and an inner periphery of said ring is fitted to an outer periphery of the heat exchange tube.

12. The heat exchanger as claimed in claim 11, wherein
the length of said ring in the axial direction is approximately equal to or greater than 30% of the length of the tubular part in the axial direction.

13. The heat exchanger as claimed in claim 11, wherein
said ring has a groove extending in the axial direction.

14. The heat exchanger as claimed in claim 11, wherein
said groove extends from an axial end portion of said ring to an axial middle portion thereof.

15. The heat exchanger as claimed in claim 1, wherein
said tubular part has a groove extending in the axial direction.

16. The heat exchanger as claimed in claim 3, wherein
said annular protrusion part has a groove extending in the axial direction.

17. The heat exchanger as claimed in claim 1, wherein
the rings are arranged in one or more rows, two adjacent rings are connected via a connecting member, and the rings respectively correspond to the tubular parts on the fins.

18. A method for manufacturing a heat exchanger, comprising the following steps:
alternately sheathing tubular parts of fins and rings onto a heat exchange tube, and
exerting a pressure in an axial direction of the heat exchange tube on the tubular parts of the fins and the rings which are alternately sheathed onto the heat exchange tube, so as to fit the tubular part together with the ring in such a way that one is sheathed onto the other.

19. The heat exchanger as claimed in claim 3, wherein
said ring is fitted to an outer periphery of the tubular part.
